(19) United States
(12) Patent Application Publication
(10) Pub. No.: US 2004/0171168 A1
(43) Pub. Date: Sep. 2, 2004

(54) Inspection pretreatment method and inspection pretreatment system of bovine spongiform encephalopathy

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/785,188

(22) Filed: Feb. 25, 2004

(30) Foreign Application Priority Data
Feb. 28, 2003 (JP) 2003-054198

(51) Int. Cl. G01N 1/00

(52) U.S. Cl. 436/174; 422/68.1

(57) ABSTRACT

A BSE inspection pretreatment method comprises a first step for homogenizing cells of a parent specimen, a second step for preparing a child specimen, a third step for decomposing protein with regard to the child specimen, a fourth step for incubate the child specimen, a fifth step for adding a reagent B for coloring blue to the incubated child specimen, a sixth step for performing a centrifugal separation treatment on the blued child specimen and discarding/disposing a supernatant liquid, a seventh step for condensing the child specimen, an eighth step for incubating the condensed child specimen, a ninth step for diluting the incubated child specimen, and a tenth step for preparing a sample for inspection for detection of pathogenic prion protein.

### CROSS-REFERENCE TO RELATED APPLICATIONS

This application is based upon and claims the benefit of priority from prior Japanese Patent Application No. 2003-054198, filed Feb. 28, 2003, the entire contents of which are incorporated herein by reference.

### BACKGROUND OF THE INVENTION

1. Field of the Invention

The present invention relates to an inspection pretreatment method and an inspection pretreatment system of bovine spongiform encephalopathy (hereinafter referred to as BSE).

2. Description of the Related Art

In recent years, it has been officially announced in England that BSE also infects people and is developed as variant Creutzfeldt-Jakob disease (vCJD) in some case. In Japan, all cattle are inspected for presence/absence of abnormal prion, that is, pathogenic prion protein with respect to cattle's brain, internal organs and the like which are sources of infection. Therefore, there has been a demand for more accurate and speedy inspection means.

As a detection method in which the pathogenic prion protein is detected from an animal tissue origin material, a detection method has been proposed in which a modifier (especially surfactant), modification method, and detection method for use are appropriately selected in accordance with a type of the animal tissue origin material that is a detection object, and accordingly even a comparatively low concentration of the pathogenic prion protein included in the animal tissue origin material can be detected quickly and simply and with high sensitivity (see Japanese Patent Application KOKAI Publication No. 11-032795 (paragraph [0026]).

In accordance with the detection method described in the above-described document, it is supposedly possible to detect even the comparatively low concentration of the pathogenic prion protein included in the animal tissue origin material. However, to perform this detection operation, a so-called pretreatment needs to be performed. Accuracy in performing this pretreatment influences a general inspection efficiency. In other words, even with the use of the detection method described in the above-described document, if the pretreatment is not accurately performed, the accurate and speedy inspection cannot be performed in general.

### BRIEF SUMMARY OF THE INVENTION

The present invention is directed to method and apparatus that substantially obviates one or more of the problems due to limitations and disadvantages of the related art.

An object of the present invention is to provide an inspection pretreatment method and inspection pretreatment system of BSE, which have any of the following advantages:

(a) it is possible to quickly and accurately detect a pathogenic prion protein;

(b) even a large amount of specimens which are inspection objects can sufficiently be handled; and

(c) the method and system are preferable in health control and are high in safety.

According to an embodiment of the present invention, an inspection pretreatment method of bovine spongiform encephalopathy, comprising:

a first step for homogenizing cells of a parent specimen;

a second step for dispensing a predetermined amount of the homogenized parent specimen so as not to include any solid, thereby preparing a child specimen;

a third step for decomposing protein with regard to the child specimen;

a fourth step for heating the child specimen in which protein is decomposed at a first predetermined temperature to incubate;

a fifth step for adding a reagent B for coloring blue the incubated child specimen;

a sixth step for performing a centrifugal separation treatment on the blued child specimen and discarding/disposing a supernatant liquid;

a seventh step for condensing the child specimen from which a supernatant liquid is discarded/disposed;

an eighth step for heating the condensed child specimen at a second predetermined temperature which is higher than the first predetermined temperature to incubate;

a ninth step for diluting the incubated child specimen; and

a tenth step for dispensing and adsorbing a predetermined amount of child specimen to a well of a micro-titer plate and preparing a sample for inspection for detection of pathogenic prion protein.

According to another embodiment of the present invention, an inspection pretreatment system of bovine spongiform encephalopathy, comprising:

a specimen conveyor including at least one pair of belt conveyor type conveyance lanes and disposed so as to be capable of conveying a specimen container; and

a plurality of pretreatment devices arranged along a conveyance path of the specimen conveyor so as to perform predetermined pretreatments,

the plurality of pretreatment devices comprises:

a carry-in unit which carries in a parent specimen container containing a sampled parent specimen and which mounts the container on the specimen conveyor;

a first barcode label issuing unit for attaching a barcode label on which predetermined information is recorded, the information including information specifying the parent specimen and for attaching the label onto the outer peripheral surface of the parent specimen container;

a cell crushing device for homogenizing cells of the parent specimen in the parent specimen container to which the barcode label has been attached by the first barcode label issuing unit;

a dispenser unit which dispenses a predetermined amount of the parent specimen homogenized by the cell crushing device so as not to include any solid and which dispenses the specimen as a child specimen in a child specimen container;

a second barcode label issuing unit for attaching a barcode label having predetermined information recorded, the information including information specifying the child specimen and for attaching the label onto the outer peripheral surface of the child specimen container;

a parent specimen refrigerator for freezing the parent specimen container in which the remaining parent specimen is contained;

a child specimen refrigerator for freezing the container in which the child specimen is contained;

a first addition unit which adds and immixes a regent to the child specimen container to decompose protein;

a first incubation device to heat the container containing the child specimen whose protein has been decomposed at a first temperature to incubate the specimen;

a second addition unit which adds the reagent to the child specimen incubated in the first incubation device and which immixes the specimen until the specimen turns blue;

a centrifugal separation unit which subjects the child specimen obtained in the second addition unit to a centrifugal separation treatment to discard/dispose a supernatant liquid;

a condensation unit which condenses the specimen and which holds the specimen in a still state;

a second incubation device which heats the container containing the child specimen condensed by the condensation unit at a second temperature set to be higher than the first temperature to incubate the specimen;

a dilution unit which adds and immixes a predetermined amount of reagent D to the child specimen incubated in the second incubation device to dilute the specimen;

an inspection sample preparation device which dispenses and adsorbs a predetermined amount of the child specimen diluted in the dilution unit to a well of a micro-titer plate to prepare a sample for inspection for detection of pathogenic prion protein; and

a carry-out unit which carries the sample for inspection prepared in the inspection sample preparation device out to an inspection chamber.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a flowchart showing a processing procedure of a BSE inspection pretreatment method according to a first embodiment of the present invention;

FIG. 2 is a perspective view showing a constitution of a BSE inspection pretreatment system according to the first embodiment;

FIG. 3A is a diagram showing parent specimen sampling means according to the first embodiment;

FIG. 3B is a diagram showing one example of a specimen container according to the first embodiment; and

FIG. 4 is a sectional view showing a constitution example of an incubation device according to the first embodiment.

### DETAILED DESCRIPTION OF THE INVENTION

An embodiment of an inspection pretreatment method and inspection pretreatment system of bovine spongiform encephalopathy according to the present invention will now be described with reference to the accompanying drawings.

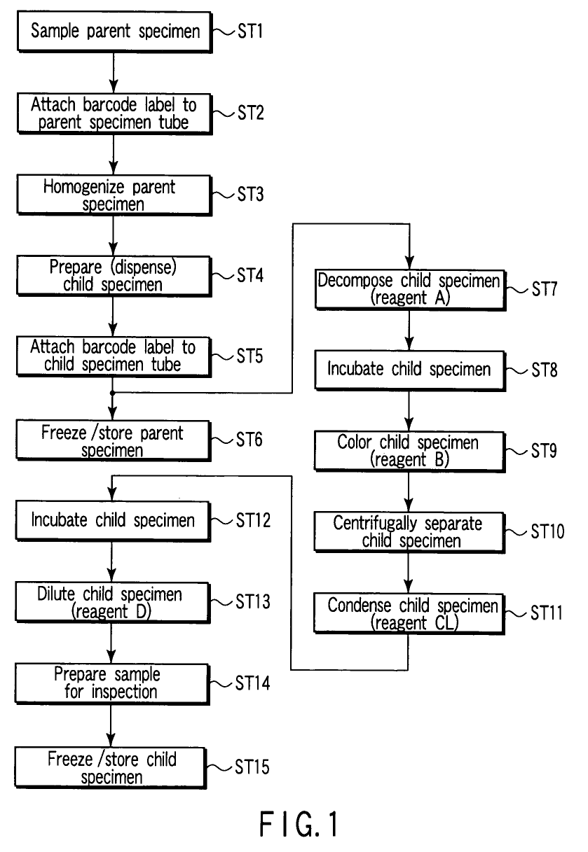

FIG. 1 is a flowchart showing a processing procedure of a BSE inspection pretreatment method according to a first embodiment of the present invention. The BSE inspection pretreatment method will be described hereinafter with reference to the flowchart.

Step ST1: A sampling syringe is used to sample about 350±40 mg of cattle's brain or spinal cord as a parent specimen in a gliding tube.

Step ST2: A barcode label on which predetermined information is recorded is attached to the gliding tube which contains the sampled parent specimen. Alternately, predetermined barcode information is printed on a label which has been already attached to the gliding tube.

Step ST3: Cells of the parent specimen in the gliding tube are sufficiently homogenized by a cell crushing device.

Step ST4: The sampling syringe is used to dispense about a predetermined amount (e.g., 500 μl) of the homogenized parent specimen so as not to include any solid, and the dispensed specimen is injected to a 2 ml-containing tube as a child specimen.

Step ST5: A barcode label on which predetermined information is recorded is attached to the tube containing the dispensed child specimen. Alternately, predetermined barcode information is printed on a label which has been already attached to the tube.

Step ST6: The remaining parent specimen is frozen/stored (and can be stored at −20° C. for several weeks and may be unfrozen only once).

Step ST7: A predetermined amount (about 500 μl) of enzyme material proteinase K which has been diluted 250 times is dispensed and is added as reagent A to the tube containing the child specimen within five minutes. Protein is decomposed by sufficient immixture.

Step ST8: The child specimen in which protein has been decomposed is set to an incubation container, heated at 37±1° C. for 10±1 minutes, and incubated.

Step ST9: A predetermined amount (about 500 l) of reagent B (enzyme material proteinase K diluted 250 times which is the same as the reagent A) is added to the incubated child specimen within two minutes, and is immixed until the solution turns blue.

Step ST10: A centrifugal separation treatment at 20,000 G for five minutes and at 15,000 G for seven minutes is performed by a cooling centrifugal separator. Then, a supernatant liquid is discarded/disposed within five minutes (the tube is turned upside down, and left to stand for five minutes, or sucked/dried for five minutes with an aspirator).

Step ST11: A predetermined amount (about 50 μl) of reagent CL (reagent C1) is added to the separated specimen within ten minutes. Accordingly, condensation is performed. Here, attentions have to be paid not to perform the immixture.

Step ST12: The condensed specimen is set to the incubation container, heated at 100±1° C. for 5±1 minutes, and incubated.

Step ST13: A predetermined amount (about 250 μl) of diluted solution (R6) of an SE kit for detection is added as reagent D to the incubated child specimen, and is well immixed.

Step ST14: A predetermined amount (about 100 μl) of child specimen is dispensed and adsorbed to a well of a micro-titer plate of the above-described SE kit to prepare and provide a sample for inspection for detection of pathogenic prion protein.

Step ST 15: The inspection is usually performed immediately after step ST 14. However, some samples may be frozen/stored for re-inspection (and can be stored at 5-8° C. for five hours, at 2-8° C. for eight hours, and at −20° C. for several weeks).

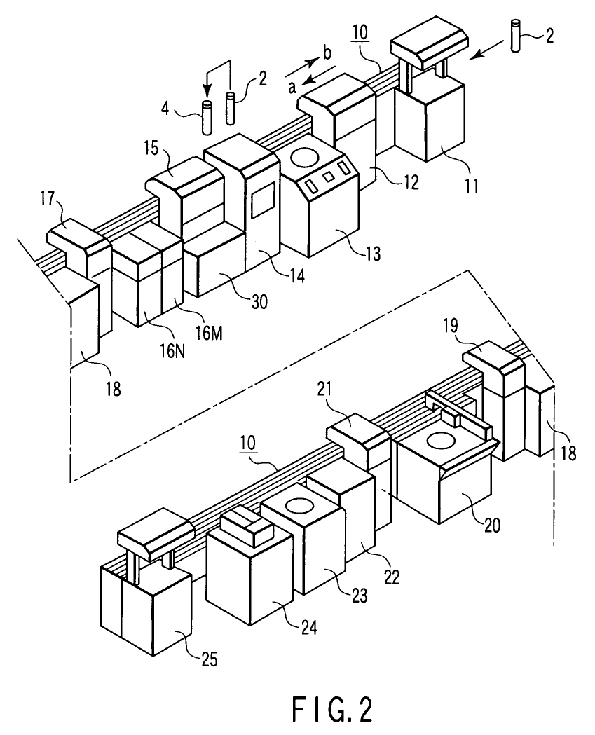

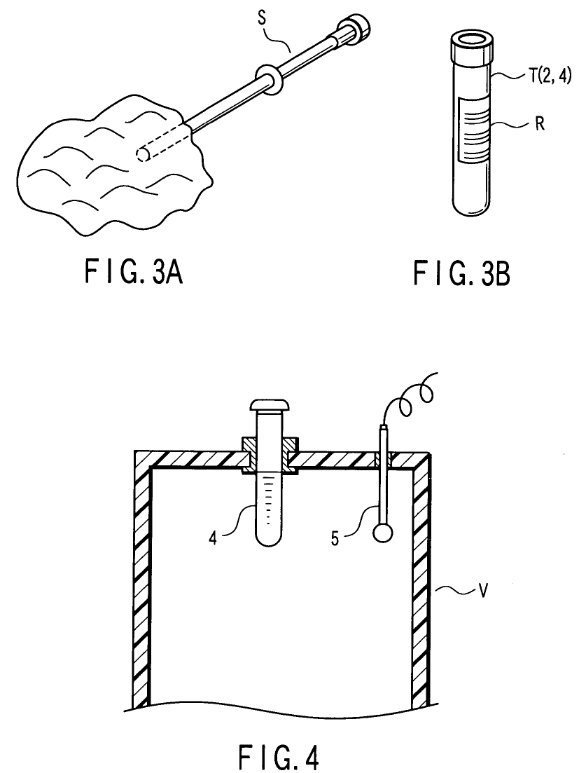

FIG. 2 is a perspective view showing a constitution of a BSE inspection pretreatment system for use in carrying out the BSE inspection pretreatment method. FIG. 3A is a diagram showing parent specimen sampling means, and FIG. 3B is a diagram showing one example of a specimen container. FIG. 4 is a sectional view showing a constitution example of an incubation device.

A specimen conveyor 10 includes at least one pair of belt conveyor type conveyance lanes, and is disposed so as to be capable of conveying specimen containers 2, 4 held in container holders to downstream from upstream as shown by an arrow a or to upstream from downstream as shown by an arrow b.

For a carry-in unit 11, about 350±40 mg of cattle's brain or spinal cord is sampled with a sampling syringe S structured as shown in FIG. 3A beforehand, and this is contained as a parent specimen M in a specimen container T (gliding tube) of a test tube type structured as shown in FIG. 3B. The parent specimen container 2 containing the specimen is successively carried in, and mounted on the specimen conveyor 10 (step ST1).

A first barcode label issuing/attaching unit 12 issues a barcode label R on which predetermined information is recorded as a barcode in accordance with contents of the carried-in parent specimen container 2 as shown in FIG. 3B, and attaches the label onto an outer peripheral surface of the parent specimen container 2 (step ST2). Alternately, the first barcode label issuing/attaching unit 12 prints predetermined barcode information on a label which has been already attached to the parent specimen container 2.

A cell crushing device 13 crushes and homogenizes the cells of the parent specimen M in the parent specimen container 2 (step ST3).

A dispenser unit 14 dispenses about 500 μl of the homogenized parent specimen M so as not to include any solid with a sampling syringe S having a structure similar to that of the above-described syringe, and sends the child specimen container 4 (step ST4). The child specimen container 4 comprises the specimen container T (2 ml containing tube) of the test tube type structured as shown in FIG. 3B in which the dispensed specimen is contained as a child specimen N.

A second barcode label issuing/attaching unit 15 issues a barcode label R on which predetermined information is recorded in accordance with contents of the sent child specimen container 4 as shown in FIG. 3B, and attaches the label to the outer peripheral surface of the child specimen container 4. Alternately, the second barcode label issuing/attaching unit 15 prints predetermined barcode information on a label which has been already attached to the child specimen container 4.

A parent specimen refrigerator 16M freezes/stores the parent specimen container 2 which contains the remaining parent specimen M (capable of storing the specimen at −20° C. for several weeks and unfreezing the specimen only once)(step ST6). The parent specimen M frozen/stored in the parent specimen refrigerator 16M is taken out at an appropriate time if needed, and conveyed to the dispenser unit 14 positioned on an upstream side. Then, a necessary dispensing operation is performed again.

A child specimen refrigerator 16N freezes/stores the child specimen container 4 which has been pretreated as shown in FIG. 1 (capable of storing the specimen at −20° C. for several weeks) (step ST15). Since the pretreatment of the child specimen container 4 is performed while it is conveyed to downstream from upstream, the pretreated child specimen container 4 is conveyed to upstream from downstream to be stored in the child specimen refrigerator 16N.

A first injection/immixture unit 17 dispenses about 500 μl of enzyme material proteinase K which has been diluted 250 times and is added as reagent A to the container 4 containing the child specimen within five minutes. Moreover, protein is decomposed by the sufficient immixture (step ST7).

A first incubation device 18 heats the container 4 containing the child specimen whose protein has been decomposed at 37±1° C. for 10±1 minutes in a container V structured as shown in FIG. 4 to incubate the specimen (step ST8). Reference numeral 5 in FIG. 4 denotes a temperature sensor which detects an inner temperature of the container V.

A second injection/immixture unit 19 adds 500 μl of reagent B to the incubated child specimen N within two minutes, and immixes the specimen until the solution turns blue (step ST9).

A centrifugal separation unit 20 performs a centrifugal separation treatment at 20,000 G for five minutes and at 15,000 G for seven minutes by a cooling centrifugal separator. Thereafter, the supernatant liquid is discarded/disposed within five minutes (the tube is turned upside down, and left to stand for five minutes, or sucked/dried for five minutes with the aspirator)(step ST10).

A condensation unit 21 adds about 50 μl of reagent CL to the child specimen N which has been subjected to the centrifugal separation treatment within ten minutes to condense the specimen. Attentions have to be paid not to perform the immixture (step ST11).

A second incubation device 22 heats the container 4 containing the condensed child specimen in the container V structured as shown in FIG. 4 at 100±1° C. for 5±1 minutes to incubate the specimen (step ST12).

A dilution unit 23 adds and well immixes about 250 μl of diluted solution (R6) of the SE kit for detection as the reagent D (step ST13).

An inspection sample preparation device 24 dispenses and adsorbs about 100 μl of solution to the well of the micro-titer plate (usually using 96-hole plate) of the above-described SE kit for the detection to prepare the pretreated sample for inspection for the detection of pathogenic prion protein (step ST14).

A carry-out unit 25 carries out the prepared sample to an inspection room (not shown). The pretreated child specimen container 4 can be conveyed to upstream from downstream to be frozen/stored in the child specimen refrigerator 16N for a later re-inspection (step ST15).

It is to be noted that the above-described pretreatment devices are associated/operated/controlled by a controller 30 disposed substantially in a middle portion of the system in such a manner that the devices operate based on commands from a host computer (not shown).

(1) An inspection pretreatment method of BSE of the present embodiment comprises:

a first step for homogenizing cells of the parent specimen M by using a cell crushing device 13;

a second step for dispensing a predetermined amount (e.g., 500 μl) of the homogenized parent specimen M so as not to include any solid and for adding the dispensed specimen to a 2 ml-containing tube as a child specimen;

a third step for adding, as reagent A, a predetermined amount (e.g., 500 μl) of enzyme material proteinase K diluted 250 times to the tube containing the child specimen within five minutes in order to decompose protein;

a fourth step for heating at 37±1° C. for 10±1 minutes the child specimen in which protein is has been decomposed in order to incubate;

a fifth step for adding a predetermined amount (e.g., 500 μl) of reagent B (same as the reagent A; enzyme material proteinase K diluted 250 times) to the incubated child specimen within two minutes and mixing the specimen until the solution turns blue;

a sixth step for performing a centrifugal separation treatment at 20,000 G for five minutes and at 15,000 G for seven minutes by a cooling centrifugal separator and discarding/disposing a supernatant liquid;

a seventh step for adding a predetermined amount (about 50 μl) of reagent CL (reagent C1) to the separated specimen to perform condensation;

an eighth step for heating the condensed specimen at 100±1° C. for 5±1 minutes to incubate;

a ninth step for adding a predetermined (about 250 μl) of diluted solution (R6) of an SE kit for detection as reagent D to the incubated child specimen and for well immixing;

a tenth step for dispensing and adsorbing a predetermined amount (about 100 μl) of child specimen to a well of a micro-titer plate of the above-described SE kit to prepare and provide a sample for inspection for detection of pathogenic prion protein.

(2) The inspection pretreatment system of BSE of the present embodiment comprises the specimen conveyor 10 including at least one pair of belt conveyor type conveyance lanes and disposed so as to be capable of conveying the specimen containers 2, 4 held in the container holders to downstream from upstream (arrow a) or to upstream from downstream (arrow b); and a plurality of pretreatment devices 11 to 25 arranged along a conveyance path of the specimen conveyor 10 so as to automatically perform predetermined pretreatments.

The plurality of pretreatment devices 11 to 25 comprise:

the carry-in unit 11 which successively carries in the parent specimen container 2 containing the sampled parent specimen M and which mounts the container 2 on the specimen conveyor 10;

the first barcode label issuing/attaching unit 12 for issuing the barcode label R on which the predetermined information is recorded including the information specifying the parent specimen in accordance with the contents of the parent specimen container 2 carried in by the carry-in unit 11 and to attach the label onto the outer peripheral surface of the parent specimen container 2;

the cell crushing device 13 for crushing and homogenizing the cells of the parent specimen M in the parent specimen container 2 to which the barcode label R has been attached by the first barcode label issuing/attaching unit 12;

the dispenser unit 14 which dispenses a predetermined amount (about 500 μl) of the parent specimen M homogenized by the cell crushing device 13 so as not to include any solid and which dispenses this specimen as the child specimen N in a predetermined amount (2 ml)-containing child specimen container 4;

the second barcode label issuing/attaching unit 15 for issuing the barcode label R having the predetermined information recorded in accordance with the contents of the child specimen container 4 to which the child specimen N has been dispensed with the dispenser unit 14 and to attach the label to the outer peripheral surface of the child specimen container 4;

the parent specimen refrigerator 16M for freezing/storing the parent specimen container 2 which contains the remaining parent specimen M in a returnable state to the dispenser unit 14 if necessary;

the child specimen refrigerator 16N for freezing/storing the container 4 in which the child specimen N is contained;

the first injection/immixture unit 17 which adds and immixes the predetermined amount of enzyme material proteinase K (diluted 250 times) as the reagent A with respect to the child specimen container 4 taken out of the child specimen refrigerator 16N to decompose the protein;

the first incubation device 18 which heats the container 4 containing the child specimen N whose protein has been decomposed in the first injection/immixture unit 17 at the set first level of temperature (37±1° C.) (for 10±1 minutes) to incubate the specimen;

the second injection/immixture unit 19 which adds the predetermined amount (about 500 μl) of reagent B to the child specimen N incubated in the first incubation device 18 and which immixes the specimen until the solution turns blue;

the centrifugal separation unit 20 which subjects the child specimen N obtained in the second injection/immixture unit 19 to the centrifugal separation treatment (at 20,000 G for five minutes and at 15,000 G for seven minutes) by the cooling centrifugal separator to discard/dispose the supernatant liquid;

the condensation unit 21 which adds the predetermined amount (about 50 μl) of reagent CL to the child specimen N subjected to the centrifugal separation treatment in the centrifugal separation unit 20 and which condenses the specimen and which holds the specimen in the still state;

the second incubation device 22 which heats the container 2 containing the child specimen condensed by the condensation unit 21 at the second level of temperature (100±1° C.) set to be higher than the first level of temperature (for 5±1 minutes) to incubate the specimen;

the dilution unit 23 which adds and immixes the predetermined amount (about 250 μl) of reagent D to the child specimen N incubated in the second incubation device 22 to dilute the specimen;

the inspection sample preparation device 24 which dispenses and adsorbs the predetermined amount (about 100 μl) of the child specimen diluted in the dilution unit 23 to the well of the micro-titer plate to prepare the sample for inspection for the detection of pathogenic prion protein; and

the carry-out unit 25 which carries the sample for inspection prepared in the inspection sample preparation device 24 out to the inspection chamber.

In accordance with the present invention, there can be provided the inspection pretreatment method and system of BSE, which have at least one of the following functions/effects.

(a) Since the child specimen is prepared from the homogenized parent specimen, the treatment can be advanced with respect to the homogenous child specimen. Since the colored child specimen is subjected to the centrifugal separation treatment, a separation result can visually be confirmed. Furthermore, the sample for inspection of the mode suitable for the inspection is prepared and provided. Therefore, it is possible to quickly and accurately detect the pathogenic prion protein.

(b) Most of the pretreatment excluding the parent specimen sampling is automatically performed by the inspection pretreatment system. Therefore, even a large amount of specimen which is the inspection object can sufficiently be handled.

(c) Since there is remarkably little manual operation, the present invention is preferable in health control and high in safety.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, the present invention can be practiced as a computer readable recording medium in which a program for allowing the computer to function as predetermined means, allowing the computer to realize a predetermined function, or allowing the computer to conduct predetermined means.

What is claimed is:

1. An inspection pretreatment method of bovine spongiform encephalopathy, comprising:
a first step for homogenizing cells of a parent specimen;
a second step for dispensing a predetermined amount of the homogenized parent specimen so as not to include any solid, thereby preparing a child specimen;
a third step for decomposing protein with regard to the child specimen;
a fourth step for heating the child specimen in which protein is decomposed at a first predetermined temperature to incubate;
a fifth step for adding a reagent B for coloring blue the incubated child specimen;
a sixth step for performing a centrifugal separation treatment on the blued child specimen and discarding/disposing a supernatant liquid;
a seventh step for condensing the child specimen from which a supernatant liquid is discarded/disposed;
an eighth step for heating the condensed child specimen at a second predetermined temperature which is higher than the first predetermined temperature to incubate;
a ninth step for diluting the incubated child specimen; and
a tenth step for dispensing and adsorbing a predetermined amount of child specimen to a well of a micro-titer plate and preparing a sample for inspection for detection of pathogenic prion protein.

2. The method according to claim 1, wherein the third step adds enzyme material proteinase K to the child specimen to decompose protein.

3. The method according to claim 2, wherein the fifth step adds enzyme material proteinase K to the child specimen to blue the child specimen.

4. The method according to claim 3, wherein the seventh step adds a reagent C1 to the separated specimen to condense the child specimen.

5. An inspection pretreatment system of bovine spongiform encephalopathy, comprising:
a specimen conveyor including at least one pair of belt conveyor type conveyance lanes and disposed so as to be capable of conveying a specimen container; and
a plurality of pretreatment devices arranged along a conveyance path of the specimen conveyor so as to perform predetermined pretreatments,
the plurality of pretreatment devices comprises:
a carry-in unit which carries in a parent specimen container containing a sampled parent specimen and which mounts the container on the specimen conveyor;
a first barcode label issuing unit for attaching a barcode label on which predetermined information is recorded, the information including information specifying the parent specimen and for attaching the label onto the outer peripheral surface of the parent specimen container;
a cell crushing device for homogenizing cells of the parent specimen in the parent specimen container to which the barcode label has been attached by the first barcode label issuing unit;
a dispenser unit which dispenses a predetermined amount of the parent specimen homogenized by the cell crushing device so as not to include any solid and which dispenses the specimen as a child specimen in a child specimen container;
a second barcode label issuing unit for attaching a barcode label having predetermined information recorded, the information including information specifying the child specimen and for attaching the label onto the outer peripheral surface of the child specimen container;
a parent specimen refrigerator for freezing the parent specimen container in which the remaining parent specimen is contained;
a child specimen refrigerator for freezing the container in which the child specimen is contained;
a first addition unit which adds and immixes a regent to the child specimen container to decompose protein;
a first incubation device to heat the container containing the child specimen whose protein has been decomposed at a first temperature to incubate the specimen;
a second addition unit which adds the reagent to the child specimen incubated in the first incubation device and which immixes the specimen until the specimen turns blue;
a centrifugal separation unit which subjects the child specimen obtained in the second addition unit to a centrifugal separation treatment to discard/dispose a supernatant liquid;
a condensation unit which condenses the specimen and which holds the specimen in a still state;
a second incubation device which heats the container containing the child specimen condensed by the condensation unit at a second temperature set to be higher than the first temperature to incubate the specimen;
a dilution unit which adds and immixes a predetermined amount of reagent D to the child specimen incubated in the second incubation device to dilute the specimen;
an inspection sample preparation device which dispenses and adsorbs a predetermined amount of the child specimen diluted in the dilution unit to a well of a micro-titer plate to prepare a sample for inspection for detection of pathogenic prion protein; and
a carry-out unit which carries the sample for inspection prepared in the inspection sample preparation device out to an inspection chamber.

6. The system according to claim 5, wherein the plurality of pretreatment devices are controlled by a controller.
